(19) United States
(12) Patent Application Publication
(10) Pub. No.: US 2003/0146928 A1
(43) Pub. Date: Aug. 7, 2003

(54) Method and system for optimal grid alignment

(76) Inventors: Paul Finster, New York, NY (US); David Ruderman, Brooklyn, NY (US); Patrice Ribero, Nice (FR)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/066,441

(22) Filed: Jan. 31, 2002

(51) Int. Cl. G09G 5/00

(52) U.S. Cl. 345/721; 345/810; 345/840

(57) ABSTRACT

A method and system for the optimal alignment of programming information using a grid, in particular the display of programming information to http client viewers in a clear, concise, and efficient manner with regular spacing per unit of time. The system creates a reference row in a programming grid, divides the reference row into a plurality of segments, each segment representing a time period shorter than that of any program in the programming grid, and aligns in the programming grid the programming information of each program according to the segments of the reference row representing each program's respective time period.

RELATED APPLICATIONS

The present application is related to commonly owned and assigned application nos.:

GIST-001/00US, entitled, System and Method for Generating Customized EPG Data and EPG Application Programs;

GIST-002/00US, entitled Method and System for Separating Static and Dynamic Data; and

GIST-004/00US, entitled Method and System for Presentation of Pre-Generated Programming Information, which are incorporated herein by reference.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to the optimal alignment of programming information using a grid.

### BACKGROUND OF THE INVENTION

In recent years, entertainment program viewers have been provided with increasing numbers of viewing choices. For example, several cable television (“CATV”) providers now offer more than 100 hundred channels of programming to their subscribers. Digital cable television providers offer more than 200 channels, and satellite television providers offer over 500 channels to their subscribers. The Internet and the increasing availability of broadband communications have introduced the availability of a practically unlimited number of sources of streaming-video and audio, representing an almost limitless diversity of content, from drama to sporting events to documentaries. Viewers can receive programming information via traditional print media or, for example, electronic programming guides that may be provided by a program provider directly through a television (“TV”) or a set-top box (e.g., an HTTP/HTML web browser that enables a TV to become a user interface to the Internet).

A problem often encountered with conventional approaches to displaying programming information to viewers (e.g., via electronic program guides or Internet programming guides) relates to displaying the grid format in a clear, concise, and efficient manner using browsers available at the client, e.g., browsers available at the set-top box. For example, programming listings grids using web browsers may often appear with irregular (i.e., disproportionate) spacing per unit of time. In some cases, the browser software automatically formats the table based on the lengths of the text within the cells. For example, if a program title is short, such as “ER,” then by using conventional approaches the corresponding grid space may be reformatted during presentation to the viewer to occupy less horizontal space than originally desired for the program title. As a result, programming information in a cell grid can get shifted with respect to its corresponding time information listed in the margin above. The horizontal space occupied by a program title of the grid cells, however, should be visually relative to the other grid cells and the time duration. Moreover, when no displayed programs begin on a certain time increment in the margin, skipped in the grid.

A specific example of a programming grid constructed according to a conventional approach is depicted in FIG. 1. In this figure, display screen 100, a Web browser window, presents programming grid 110 to a viewer. Programming grid 110 includes channel column 120 and programming information rows 130. Channel column 120 lists the name of a TV channel on each row, and programming information rows 130 display the programs scheduled to air on those channels. Time row 140 attempts to show the viewer what time a program is scheduled to air, but all program blocks do not line up correctly with time row 140.

For instance, time row 140 depicts a first time period of 12:00 a.m.-12:30 a.m. and a second time period of 12:30 a.m.-1:00 a.m. (“00h00” and “00h30” represent midnight and 12:30 a.m., respectively, in 24-hr time notation.) The left arrowhead on time row 140 next to “00h00” actually represents the first five minutes of the first time period, and the right arrowhead at the right end of time row 140 represents the last five minutes of the second time period.

However, based on the alignment of time row 140 in programming grid 110, it appears that the first time period is longer than the second, even though both represent 30 minute intervals. Also, based on the alignment of the program blocks with respect to time row 140, it appears that the third program on channel “FRANCE 2” (represented by the ellipsis to the right of the “Journal de . . . ” program block) is longer than the “Journal de . . . ” program and starts around 12:15 a.m., wherein the third program actually is five minutes shorter than the “Journal de . . . ” program and starts at 12:20 a.m.

Accordingly, there is a need in the art for a system and method that displays programming information to viewers in a clear, concise, and efficient manner with proportional width per unit of time.

Although present devices are functional, they are not sufficiently accurate or otherwise satisfactory. Accordingly, a system and method are needed to address the shortfalls of present technology and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention is generally directed to a method and system for presenting a programming grid with proportional width per unit time in a clear, concise, and efficient manner. One embodiment the invention can automatically optimize the display screen to provide a proportionally-spaced grid that displays programming information more clearly. The grid can maintain its formatting irrespective of the browser that is used to display the programming grid.

In one embodiment, the invention provides the proportionally-spaced grid by creating a hidden reference row in an otherwise visible programming grid, dividing the reference row into a plurality of segments, each segment representing a time period, e.g., one minute, shorter than that of any program in the programming grid, and aligning in the programming grid the programming information of each program according to the segments of the reference row representing each program's respective time period.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a screen shot that depicts a programming grid according to a conventional approach to displaying programming information;

FIG. 2 is a block diagram that depicts a network architecture in accordance with an embodiment of the present invention;

FIG. 3 is flow chart that illustrates a process for presenting a programming grid with regular spacing per unit time in accordance with an embodiment of the present invention;

FIG. 4 is a screen shot that depicts a programming grid in accordance with an embodiment of the present invention; and

FIG. 5 is a screen shot that depicts a programming grid in accordance with an embodiment of the present invention.

### DETAILED DESCRIPTION

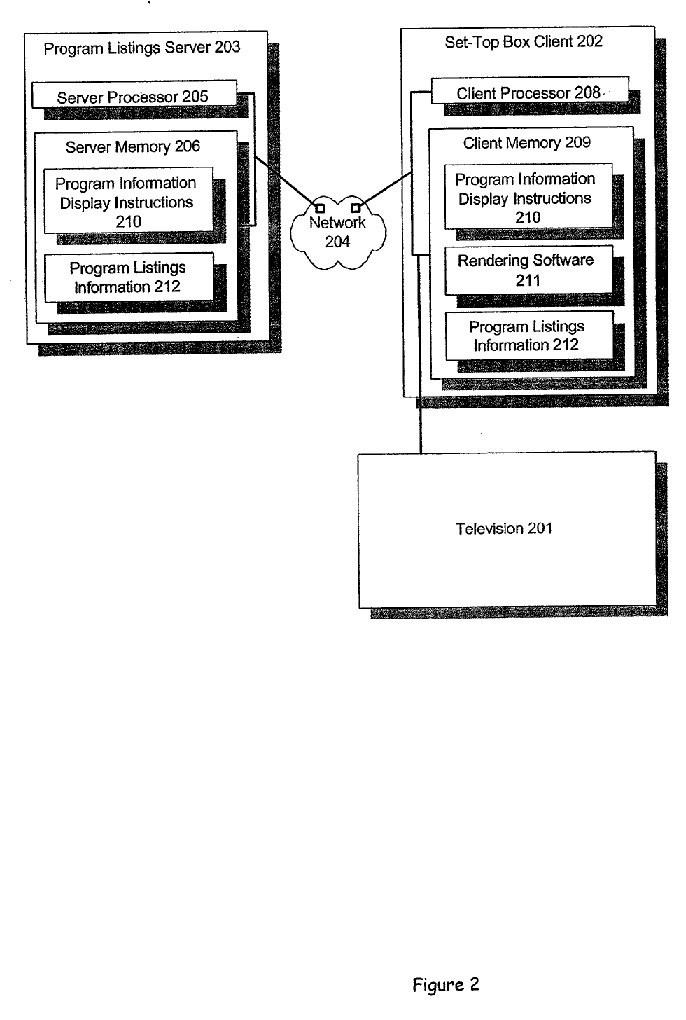

Referring now to the drawings, where like or similar elements are designated with identical reference numerals throughout the several views, and referring in particular to FIG. 2, it illustrates a network architecture in accordance with one embodiment of the present invention. Television 201 is coupled to set-top box client 202 (possible an HTTP/HTML web browser client application), which in turn is coupled to program listings server 203 through network 204. Other embodiments of the present invention include a personal computer with a browser.

Program listings server 203 includes server processor 205 coupled to server memory 206. Server processor 205 can include, among others, a general purpose microprocessor, or an Application Specific Integrated Circuit (“ASIC”) that embodies at least a part of the method in accordance with an embodiment of the present invention in its hardware and/or firmware. Likewise, server processor 205 can also be a combination of microprocessors and/or ASICs.

Server memory 206 can be any device adapted to store electronic information, such as Random Access Memory, Read Only Memory, a hard disk, a Compact Disk Read Only Memory (CD-ROM), etc. At least part of server memory 206 should be writeable as well as readable. Server memory 206 may store program information display instructions 210 (software) and program listings information 212 that can be downloaded through network 204 to set-top box client 202. Program information display instructions 210 may include HTML code with embedded Javascript, or any other interpreted language code, for rendering program listings information 212.

Television 201 is viewed by a viewer. Television 201 is an example of a display device on which programs and programming information can be displayed to the viewer. Additional examples of display devices include a computer monitor, a display on a handheld device such as a PDA, cell phone, or remote control, a heads-up display, a projection display, etc.

Set-top box client 202 includes a client processor 208 coupled to client memory 209. As with server processor 205, client processor 208 can include, among others, a general purpose microprocessor or an ASIC that embodies at least a part of the method in accordance with an embodiment of the present invention in its hardware and/or firmware. Likewise, client processor 208 can be a combination of microprocessors and/or ASICS.

Client memory 209, like server memory 206, can be any device adapted to store electronic information, such as Random Access Memory, Read Only Memory, a hard disk, a Compact Disk Read Only Memory (CD-ROM), etc. At least part of client memory 209 should be writeable as well as readable. Client memory 209 may store rendering software 211 adapted to be executed by client processor 208, along with program information display instructions 210 and program listings information 212 that may be downloaded from program listings server 203. Rendering software 211 may render program listings information 212 in accordance with program information display instructions 210.

Rendering software 211 can also be interactive, and receive and process input from the viewer (e.g., from a television remote control, a keyboard, a mouse, a handheld wireless device, etc.) Rendering software 211 may share the functions of well-known browser software, such as Internet Explorer or can be an interpreted-language engine, such as a Javascript engine.

Network 204 can be any network and/or system of networks. Examples of network 204 include the Internet, a wireless network, the Public Switched Telephone Network (“PSTN”), a Local Area Network (“LAN”), a Wide Area Network (“WAN”), wireless network, infra-red-based network, ultrasonic network, WAP-based network, CDMA 2000-based network, W-CDMA-based network, etc.

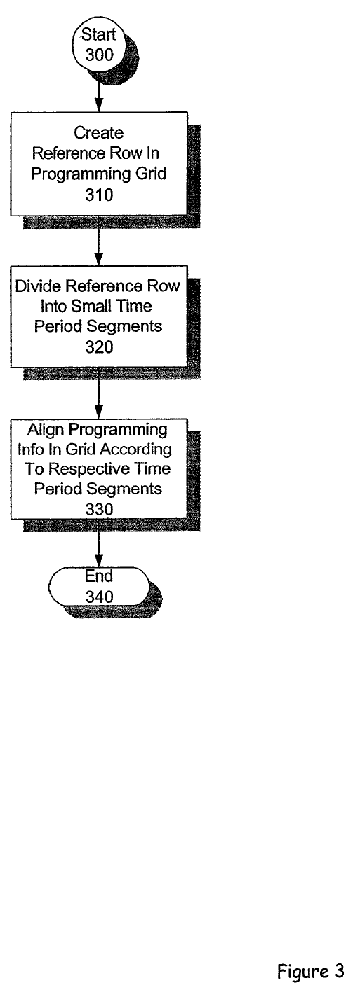

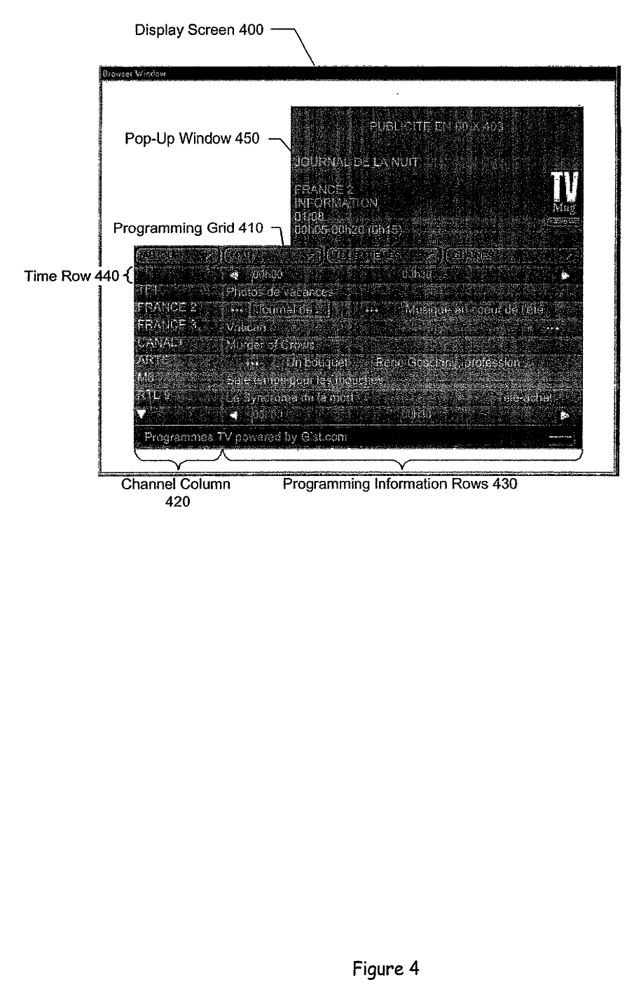

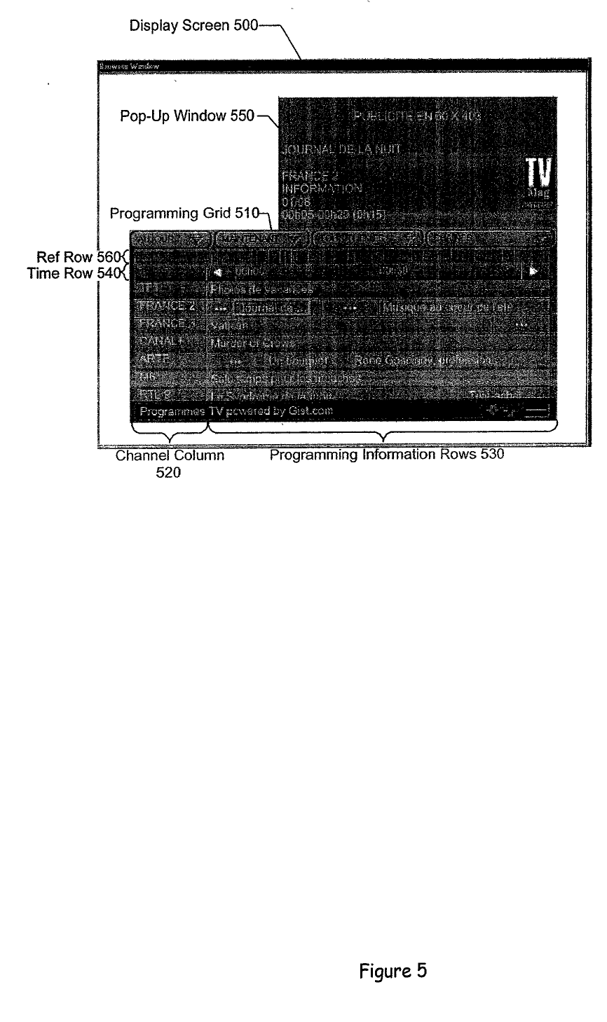

FIG. 3 illustrates a process for displaying a programming grid with proportional spacing per unit time in accordance with an embodiment of the present invention, with FIGS. 4 and 5 illustrating exemplary display screens of the resulting programming grids. According to this process, program information display instructions 210 create a hidden reference row in the programming grid (step 310), and then divide the reference row into small time period segments (step 320). In one embodiment, each time period segment is shorter than that of any program in the programming grid. Next, program information display instructions 210 align the programming information in the grid according to the segments representing each program's respective time period (step 330). If necessary, program titles can be removed, abbreviated, truncated, and/or replaced by an image to guarantee that the grid cells are proportional to the deviation of the related show. Other information can also be displayed in the proportionally-spaced grid cells. For example, episode name, description, genre, HTML links, images and other objects can be sized and displayed in the grid cell.

In other embodiments, the present invention can use hidden images to generate a programming grid with proportional spacing per unit of time. For example, a hidden image with a fixed width can be added to a hidden row included in the grid. This hidden image would help the browser size the individual grid cells. For example, the image <IMG Bordered=0 SRC=empty.gif WIDTH=30> fixes the width for 30 minutes or some multiple thereof. In this embodiment, the grid width would be measured in pixels. In another embodiment, hidden images are inserted at the top or bottom of each grid cell. A hidden row is not necessarily needed. In yet another embodiment, cells include full images of title, start time, etc., with proper width. For example, the listing information for the show “Friends” could be transcoded into an image<IMG SRC=Friends20010305.gifWIDTH=30> and inserted into a grid cell.

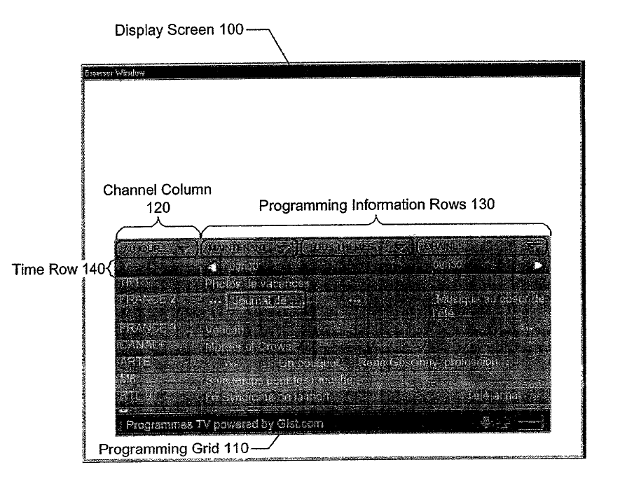

FIG. 4 illustrates display screen 400, a Web browser window, which presents programming grid 410 to a viewer. Programming grid 410 includes channel column 420 and programming information rows 430. Channel column 420 lists the name of a TV channel on each row, and programming information rows 430 display the programs scheduled to air on those channels. Time row 440 accurately shows the viewer what time a program is scheduled to air, because all program blocks line up correctly with time row 440, unlike those in FIG. 1. Popup window 450 appears with detailed program information as the viewer positions the input device over the corresponding program.

FIG. 5, like FIG. 4, illustrates display screen 500, a Web browser window, which presents programming grid 510 to a viewer. Programming grid 510 includes channel column 520 and programming information rows 530. Channel column 520 lists the name of a TV channel on each row, and programming information rows 530 display the programs scheduled to air on those channels. Time row 540 accurately shows the viewer what time a program is scheduled to air, because all program blocks line up correctly with time row 540, unlike those in FIG. 1. Pop-up window 550 appears with detailed program information as the viewer selects a program with the input device. FIG. 5 additionally includes reference row 560, which is invisible in the embodiment shown in FIG. 4.

The following HTML code illustrates part of the low-level implementation of programming grid 410:

<TABLE border=0 cellpadding=0 cellspacing=0 width=100% align=center>
<!-- Invisible Reference Row -->
<!-- One cell per minute. One hour grid width, so 60 cells -->
<TR>

<TD width=132 height=0></TD>
<TD width=9 height=0 colspan=1></TD>
<TD width=9 height=0 colspan=1></TD>
<TD width=9 height=0 colspan=1></TD>
. . . a total of 60 such rows. . .
<TD width=9 height=0 colspan=1></TD>
<TD width=9 height=0 colspan=1></TD>

</TR>
<!-- Time Row -->
<TR>

<TD height=26 width=132 align=left valign=top>

&nbsp;

</TD>
<TD height=26 colspan=5 align=left valign=top>

<IMG src=/soc3/partners/tak/images/empty.gif height=26 width=1 hspace=0 vspace=0

align=absmiddle>
<A href=“/soc3/partners/tak/grid.jsp?startdate=7/31/2000&starttime

=11pm”>
<IMG src=“/soc3/partners/tak/images/leftarrow.gif” border=0>

</A>

</TD>
<TD height=26 colspan=25 align=left valign=top>

<IMG src=/soc3/partners/tak/images/empty.gif height=26 width=1 hspace=0
vspace=0 align=absmiddle>

00h00

</TD>
<TD height=26 colspan=25 align=left valign=top>

<IMG src=/soc3/partners/tak/images/empty.gif height=26 width=1 hspace=0

vspace=0 align=absmiddle>

00h30

</TD>
<TD height=26 colspan=5 align=left valign=top>

<IMG src=/soc3/partners/tak/images/empty.gif height=26 width=1 hspace=0

vspace=0 align=absmiddle>

<A href=“/soc3/partners/tak/grid.jsp?startdate8/1/2000&starttime

<1am”>
<IMG src=“/soc3/partners/tak/images/rightarrow.gif” border=0>

</A>

</TD>

</TR>
<!-- A Program Row (i.e., “France 2” channel) -->
<!-- If the duration of a program is x minutes, its “colspan” attribute will

be equal to x -->

<TR>

<TD width=132 height=26 align=left valign=top>

&nbsp;FRANCE 2

</TD>
<TD height=26 colspan=5 align=left valign=top>

<IMG src=/soc3/partners/tak/images/empty.gif height=26 width=1 hspace=0

vspace=0 align=absmiddle>

<A href=“/soc3/partners/tak/programme.jsp?pid=775618&d=5”

onMuseOver=“updateTip(&quot;CLIP DE LA MUSIQUE\n\Nfrance

2\nCLIPS\n01/08\n23h55-00h05 (0h10)&quot;)”

onMouseOut=“updateTip(&quot;&quot;)”
target=_top>
<IMG src=/soc3/partners/tak/images/empty.gif height=0 width=7

hspace=0 vspace=0 align=absmiddle>

<IMG src=/soc3/partners/tak/images/dot.gif width=28 height=26

border=0 hspace=0 vspace=0 >

<IMG src=/soc3/partners/tak/images/empty.gif height=0 width=7

hspace=0 vspace=0 align=absmiddle>

</A>

</TD>
<TD height=26 colspan=15 align=left valign=top>

<IMG src=/soc3/partners/tak/images/empty.gif height=26 width=1 hspace=0

vspace=0 align=absmiddle>

<A href=“/soc3/partners/tak/programme.jsp?pid=775619&d=15”

onMouseOver=“updateTip(&quot;JOURNAL DE LA NUIT\n\nFRANCE
2/nINFORMATION\n01/08\n00h05-00h20 (0h15)&quot;)”
onMouseOut=“updateTip(&quot;&quot;)”
target=_top>
<LIMITTEXT width=“120” value=“Journal de la nuit”>

</A>

</TD>
<TD height=26 colspan=10 align=left valign=top>

<IMG src=/soc3/partners/tak/images/empty.gif height=26 width=1 hspace=0

vspace=0 align=absmiddle>

<A href=“/soc3/partners/tak/programme.jsp?pid=775620&d=10”

onMouseOver=“updateTip(&quot;METEO 2\n\nFRANCE 2\n\n01/08\n00h20

00h30 (0h10)&quot;)”

onMouseOut=“updateTip(&quot;&quot;)”
target=_top>

<IMG src=/soc3/partners/tak/images/empty.gif height=0 width=30

hspace=0 vspace=0 align=absmiddle>

<IMG src=/soc3/partners/tak/images/dot.gif width=28 height=26

border=0 hspace=0 vspace=0>

<IMG src=/soc3/partners/tak/images/empty.gif height=0 width=30

hspace=0 vspace=0 align=absmiddle>

</A>

</TD>
<TD height=26 colspan=30 align=left valign=top>

<IMG src=/soc3/partners/tak/images/empty.gif height=26 width=1 hspace=0

vspace=0 align=absmiddle>

<A href=“/soc3/partners/tak/programme.jsp?pid=775621&d=30”

onMouseOver=“updateTip(&quot;MUSIQUE AU COEUR DE L‘ÉTÉ\n\nFRANCE
2\nMAGAZINE/MUSICAL\n01/08\n00h30-01h30 (1h00)&quot;)”
onMouseOut=“updateTip(&quot;&quot;)”
target=_top>
<LIMITTEXT width=“240” value=“Musique au coeur de l‘tété”>

</A>

</TD>

</TR>
</TABLE>

1

2

3

4

5

6

7

8

9

10

11

12

13

14

15

16

17

18

19

20

21

22

23

24

25

26

27

28

29

30

31

32

33

34

35

36

37

38

39

40

41

42

43

44

45

46

47

48

49

50

51

52

53

54

55

56

57

58

59

60

61

62

63

64

65

66

67

68

69

70

71

72

73

74

75

76

77

78

79

80

81

82

83

84

85

86

87

88

89

90

91

92

93

94

95

96

97

98

99

100

101

102

103

104

105

106

107

108

109

110 . . .

The HTML code above defines a table (lines 1-111), which includes an invisible reference row (lines 3-13), a time row (lines 15-46), and a program row (lines 48-109). The table is rendered as programming grid 410, the reference row is invisible (i.e., height=0), the time row is rendered as time row 440, and the program row is rendered as the “FRANCE 2” channel, or row, in programming grid 410. Step 310 of the embodiment of FIG. 4 is implemented by the creation of the reference row, step 320 is implemented by the structure of the reference row, and step 330 is implemented by the formatting of the time row and program row.

The creation and structure of the reference row divides the table into 60 evenly-spaced segments, or columns—each column representing one minute. Each column, 9 pixels wide (due to the “width” attribute”), represents one minute, hence the total of 60 row elements (see lines 7-12). In other embodiments, the proportional width can be displayed in multiple or fractional increments such as 2 minutes=1 pixel/column or 1 minute=3 pixels/columns. (The 60 elements do not cover the portion of time row 440 spanned by channel column 420.) As in FIG. 1, time row 440 depicts a first time period of 12:00 a.m.-12:30 a.m. and a second time period of 12:30 a.m.-1:00 a.m. (“00h00” and “00h30” represent midnight and 12:30 a.m., respectively, in 24-hr time notation.) The left arrowhead on time row 440 next to “00h00” actually represents the first five minutes of the first time period, and the right arrowhead at the right end of time row 440 represents the last five minutes of the second time period. Unlike FIG. 1, the programs in FIG. 4 are properly aligned with time row 440 due to the formatting of the time row and program row.

The formatting of the time row and program row in FIG. 4 occurs by setting the appropriate “colspan” attribute for each table cell. In HTML, the “colspan” attribute of a table cell specifies the number of columns spanned by that cell. Since each column represents one minute of programming information in programming grid 410, one need only set the “colspan” attribute to the number of minutes one wishes the cell to represent. For example, the setting (in bold) of “colspan=5” at line 20 shows that the left arrowhead cell in time row 440 represents the first five minutes of the first time period. Similarly, the setting (in bold) of “colspan=25” at line 28 shows that the cell containing “00h00” represents the remaining 25 minutes of the first time period. The same holds true for the “colspan” settings at lines 33 and 38 (which represent the time periods of the “00h30” cell and the right arrowhead cell, respectively).

To continue the example for the “FRANCE 2” program row in programming grid 410, the setting (in bold) of “colspan=5” at line 55 shows that the leftmost “. . . ” program cell in the “FRANCE 2” program row represents the first five minutes of the first time period. This is confirmed by noting the programming information associated with this program at lines 59-60, which states that the program “CLIP DE LA MUSIQUE” runs from 23h55 (11:55 p.m.) to 00h05 (12:05 a.m.). This information would be displayed in pop-up window/4/50 if the input device were positioned over that cell (via the onMouseOver attribute).

Similarly, the setting (in bold) of “colspan=15” at line 71 shows that the “Journal de . . . ” program cell in the “FRANCE 2” program row represents the 15-minute long program “JOURNAL DE LA NUIT”, which runs from 00h05 (12:05 a.m.) to 00h20 (12:20 a.m.). This program information is found on lines 75-76, which is displayed in pop-up window 450 due to the positioning of the input device over the corresponding program cell (note the border around the program cell illustrating which program corresponds to the information in pop-up window 450). Note that the timing of the program aligns correctly with it's respective time period on time row 440.

Thus, this embodiment of the present invention solves the alignment problems of FIG. 1. For example, the two ½ hour time periods in time row 440 appear to be the same length, and the third program on the “FRANCE 2” channel, which is 10 minutes long (see lines 82 and 86-87), actually appears shorter than the 15-minute long “JOURNAL DE LA NUIT” program. Also, both appear correctly aligned with time row 440.

The above HTML code would similarly illustrate those parts of the low-level implementation of programming grid 510, if the expressions “height=0” at lines 6-12 were replaced with “height=26”. This action would make the invisible reference row discussed above visible, as shown by reference row 560 in FIG. 5.

Additionally, since the “width” attribute may not be well supported among all HTTP/HTML web browsers, one may in an alternative embodiment place a fixed-length image or characters in a table cell to force the width. For example, instead of:

<TD width=9 height=0 colspan=1></TD>

at lines 7-12, one may use:

<TD colspan=1><IMG width=9 height=1 src=“empty.gif”></IMG></TD>

In conclusion, the present invention provides, among other things, a system and method for providing proportional alignment of information within a grid. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for presenting programming information to a viewer, comprising:
creating a reference row in a programming grid;
dividing the reference row into a plurality of segments, each segment representing a time period shorter than that of any program in the programming grid; and
aligning in the programming grid the programming information of each program according to the segments of the reference row representing each program's respective time period.

2. The method of claim 1, wherein the reference row comprises a hidden reference row.

3. The method of claim 2, wherein the creation of the reference row includes:
adding a row to the programming grid.

4. The method of claim 3, wherein the division of the reference row into a plurality of segments comprises:
dividing the reference row into a plurality of segments, each segment representing a one-minute interval.

5. The method of claim 4, wherein the width of the segments is fixed by a width attribute.

6. The method of claim 1 further comprising:
retrieving the programming information.

7. The method of claim 4, wherein the aligning of the programming information includes:
adding columns to the programming grid such that each row is divided by the columns; and
spanning the programming information of each program across a number of columns in a row, wherein the number of columns is proportional to the deviation of the program associated with the programming information.

8. An apparatus to present programming information to a viewer, comprising:
a communications device;
a processor;
and a memory storing a plurality of instructions to be sent by the processor via the communication device to an http client for execution, the instructions to be executed by the http client to create a reference row in a programming grid, the executed instructions further to divide the reference row into a plurality of segments, each segment representing a time period shorter than that of any program in the programming grid, the executed instructions further to align in the programming grid the programming information of each program according to the segments of the reference row representing each program's respective time period.

9. The apparatus of claim 8, wherein the programming grid includes an HTML table.

10. The apparatus of claim 9, wherein the creation of the reference row includes adding a row to the HTML table.

11. The apparatus of claim 10, wherein the division of the reference row into a plurality of segments includes adding columns to the reference row in the HTML table, each column representing one of the segments.

12. The method of claim 11, wherein the width of the columns is fixed by at least one of a width attribute and a fix-length image.

13. The apparatus of claim 8, wherein the reference row is one of visible and invisible to the viewer.

14. The apparatus of claim 11, wherein the aligning of the programming information includes spanning the programming information of each program across the columns representing each program's respective time period.

15. A system for presenting programming information to a viewer, comprising:
means for creating a reference row in a programming grid;
means for dividing the reference row into a plurality of segments, each segment representing a time period shorter than that of any program in the programming grid; and
means for aligning in the programming grid the programming information of each program according to the segments of the reference row representing each program's respective time period.
